(19) United States
(12) Patent Application Publication
(10) Pub. No.: US 2016/0349979 A1
(43) Pub. Date: Dec. 1, 2016

(54) Multiple Brush Strokes Preview

(71) Applicant: Adobe Systems Incorporated, San Jose, CA (US)

(72) Inventors: Werner L. Sharp, Allantown, WA (US); Sebastian Marketsmueller, San Francisco, CA (US); Erik Jon Natzke, San Francisco, CA (US); Christopher K. Nuuja, San Anselmo, CA (US)

(21) Appl. No.: 14/724,278

(22) Filed: May 28, 2015

(51) Int. Cl. G06F 3/0488; G06T 11/00; G06T 11/40; G06F 3/041

(52) U.S. Cl. CPC G06F 3/04883; G06F 3/0412; G06T 11/001; G06T 11/40

(57) ABSTRACT

In embodiments of multiple brush strokes preview, a computing device implements a virtual brush application, and a virtual brushes interface is displayed that includes brush drawing surfaces, where each brush drawing surface corresponds to a virtual brush of a brush type. A drawing input can be received in one of the brush drawing surfaces in the virtual brushes interface. A brush segment of the virtual brush that corresponds to the brush drawing surface is generated, and the brush segment is displayed in the brush drawing surface in the form of the drawing input. Additionally, brush segments of all the virtual brushes are generated approximately simultaneously for display in the corresponding brush drawing surfaces, where each of the brush segments are displayed in the corresponding brush drawing surface in the form of the drawing input.

### BACKGROUND

Many device users have portable electronic and computing devices, such as mobile phones, tablet computers, multimedia devices, and similar mobile devices. These types of mobile devices are increasingly designed with more memory and processing capabilities, and generally include a camera device that can be utilized to capture digital images. With the increased memory and processing capabilities, these types of mobile devices can also be used to run imaging applications, such as may be used for image processing and/or sketch creation. These imaging applications that are designed for user interaction to create sketches and other artwork generally include or support multiple brush types, which a user can select to draw in a sketch interface, paint on a virtual canvas, and the like.

The imaging applications that support the multiple brush types typically display the available brushes in a user interface as a list or grid of static image thumbnails, where each thumbnail displays an example path or segment drawn with a brush to show the type of result expected when the brush is selected for use. To determine an actual result of using a particular brush in an image of a sketch, painting, or other artwork, the user has to select the brush and create a brush stroke in the image. If the user then does not like the appearance of brush type, the user has to erase or undo the brush stroke input and start over with selecting a different brush to try in the image. This can be frustrating to the user and result in an unfavorable user experience when working with a particular imaging application.

### SUMMARY

This Summary introduces features and concepts of multiple brush strokes preview, which is further described below in the Detailed Description and/or shown in the Figures. This Summary should not be considered to describe essential features of the claimed subject matter, nor used to determine or limit the scope of the claimed subject matter.

Multiple brush strokes preview is described. In embodiments, a computing device implements a virtual brush application, and a virtual brushes interface is displayed that includes brush drawing surfaces, where each brush drawing surface corresponds to a virtual brush of a brush type. A drawing input can be received in one of the brush drawing surfaces in the virtual brushes interface. A brush segment of the virtual brush that corresponds to the brush drawing surface is generated, and the brush segment is displayed in the brush drawing surface in the form of the drawing input. Additionally, brush segments of all the virtual brushes are generated approximately simultaneously for display in the corresponding brush drawing surfaces, where each of the brush segments are displayed in the corresponding brush drawing surface in the form of the drawing input.

In implementations, the brush segments of all the virtual brushes are generated approximately simultaneously for display as a multiple brush strokes preview of the respective brush types in the virtual brushes interface. A scroll input can be received to scroll the display of the virtual brushes interface, which displays additional brush drawing surfaces that each correspond to an additional virtual brush of a different brush type. The brush segments of the additional virtual brushes are displayed in the corresponding additional brush drawing surfaces, and each of the brush segments are displayed in the form of the drawing input as a result of the brush segments of the additional virtual brushes being generated when the brush segments of all the virtual brushes are generated.

In implementations, the virtual brushes that are displayed in the virtual brushes interface are organized in a brush library. A user input can be received as a library input to select a different brush library of additional virtual brushes, which displays additional brush drawing surfaces that each correspond to one of the additional virtual brushes of a different brush type. The brush segments of the additional virtual brushes are displayed in the corresponding additional brush drawing surfaces, and each of the brush segments are displayed in the form of the drawing input as a result of the brush segments of the additional virtual brushes in the different brush library being generated when the brush segments of all the virtual brushes are generated. A user touch input can also be received within a brush drawing surface of a virtual brush to initiate a brush template interface that can be utilized to edit the virtual brush and/or create additional virtual brushes. The brush template interface includes an editable preview of the brush segment of the virtual brush, and the brush segment of the virtual brush is displayed in the form of the drawing input.

### BRIEF DESCRIPTION OF THE DRAWINGS

Embodiments of multiple brush strokes preview are described with reference to the following Figures. The same numbers may be used throughout to reference like features and components that are shown in the Figures:

FIG. 1 illustrates an example of a mobile device in which embodiments of multiple brush strokes preview can be implemented as described herein.

FIG. 2 illustrates an example of multiple brush strokes preview in accordance with one or more embodiments as described herein.

FIG. 3 illustrates another example of multiple brush strokes preview in accordance with one or more embodiments as described herein.

FIG. 4 illustrates another example of multiple brush strokes preview implemented on a mobile device in accordance with one or more embodiments as described herein.

FIG. 5 illustrates an example system in which embodiments of multiple brush strokes preview can be implemented.

FIG. 6 illustrates example methods of multiple brush strokes preview in accordance with one or more embodiments of the techniques described herein.

FIG. 7 illustrates additional example methods of multiple brush strokes preview in accordance with one or more embodiments of the techniques described herein.

FIG. 8 illustrates an example system with an example device that can implement embodiments of multiple brush strokes preview.

### DETAILED DESCRIPTION

Embodiments of multiple brush strokes preview are described, and the techniques enable a user of a mobile device, such as a mobile phone or tablet device, to simultaneously preview virtual brushes of different brush types in a virtual brushes interface. Brush segments for each of the virtual brushes are displayed in a corresponding brush drawing surface in the virtual brushes interface. A user of the mobile device can initiate a touch and hold input in one of the brush drawing surfaces in the virtual brushes interface, and all of the individual brush drawing surfaces are cleared of the last displayed brush segment of the respective virtual brush, allowing the user to draw a new brush segment. The user can then initiate a drawing input in the one brush drawing surface that is selected and a brush segment of the virtual brush that corresponds to the brush drawing surface is generated. The brush segment that is drawn by the user is displayed in the brush drawing surface in the form of the drawing input. Additionally, brush segments of all the virtual brushes are generated approximately simultaneously for display in all of the corresponding brush drawing surfaces, and each of the brush segments are displayed in the corresponding brush drawing surface in the form of the drawing input from the user.

As the user draws a brush segment in any one of the drawing surfaces, the input data of the brush segment that is being drawn is delivered to all of the brush drawing surfaces simultaneously, which then causes all of the brush segments in the brush drawing surfaces to update synchronously in real-time for a multiple brush strokes preview. The techniques of multiple brush strokes preview allow a user to then preview what all of the brush types look like for the input drawing path or drawing form of the one particular selected brush segment. With the multiple brush strokes preview displayed in the virtual brushes interface, the user can scribble or draw just one brush segment input with a selected virtual brush and see the effect on all of the brush styles in a live preview mode. As a user convenience, this provides a time-savings efficiency, rather than having to select and try out each brush individually on a canvas or in an image, and then having to erase or undo the brush strokes and start over if the user does not like the appearance of the brush type. The multiple brush strokes preview also conserves processing resources and device power by the user not having to go through the select, draw, and erase or undo process for each brush to find a brush type that is suitable for a particular application.

While features and concepts of multiple brush strokes preview can be implemented in any number of different devices, systems, networks, environments, and/or configurations, embodiments of multiple brush strokes preview are described in the context of the following example devices, systems, and methods.

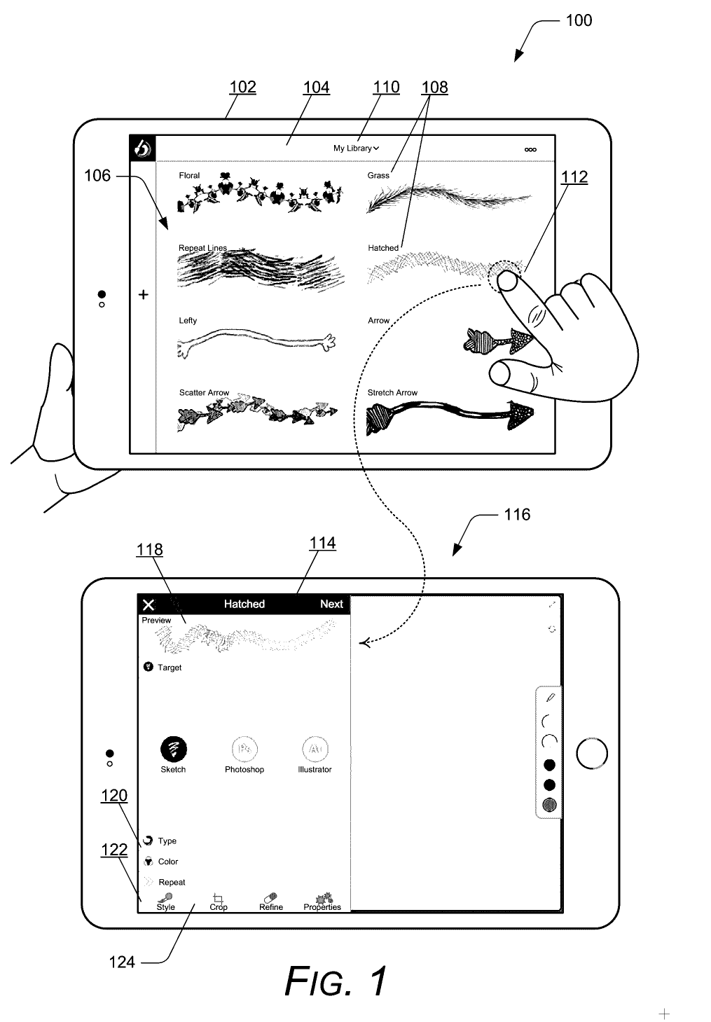

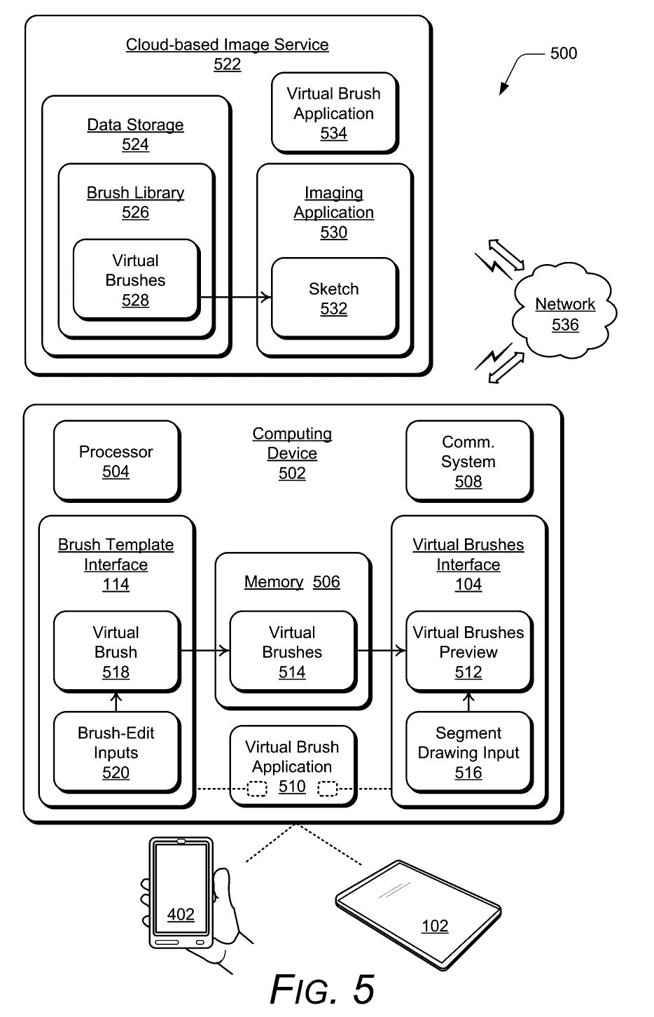

FIG. 1 illustrates an example 100 of a mobile device, such as a tablet device 102 shown in this example or a mobile phone, in which embodiments of multiple brush strokes preview can be implemented. As detailed in the system description shown in FIG. 5, the tablet device 102 can display a virtual brushes interface 104 of a virtual brush application. The virtual brushes interface 104 displays multiple virtual brushes 106 of various brush types 108, such as “floral”, “grass”, “hatched”, “arrow”, and any other brush types as shown in this example. The virtual brushes 106 are also referred to herein as simply brushes 106, and in this instance, are displayed together in a brush library 110, which is identified as “My Library” to indicate a brush library of the user of the tablet device. In implementations, the brush library 110 of the multiple virtual brushes may be provided with the virtual brush application, or a brush library with different virtual brushes of various brush types can be created by the user of the device.

For example, the user can touch-select one of the virtual brushes 106, such as the “hatched” brush type at 112 to initiate a brush template interface 114 as shown at 116. The brush template interface 114 includes the selected “hatched” brush type displayed in a preview section 118 of the brush template interface, and the preview of the brush changes with brush-edit inputs. The user can modify and/or create a new brush type in the brush template interface 114, and the modified or new brush type can be saved in a brush library with different virtual brushes of various brush types as created by the user of the device. In this example, the brush template interface 114 includes selectable brush-edit controls, such as a type of brush control and a color control shown at 120. Any number of other various brush creation and edit controls can be implemented for user selection and application to modify and/or create brush styles of virtual brushes. In this example, the brush template interface 114 also includes additional brush-edit controls 122 displayed in a tool bar 124 of the brush template interface, such as a style, crop, refine, and properties controls that a user can select to edit the brush type before being saved as a brush template in the brush library.

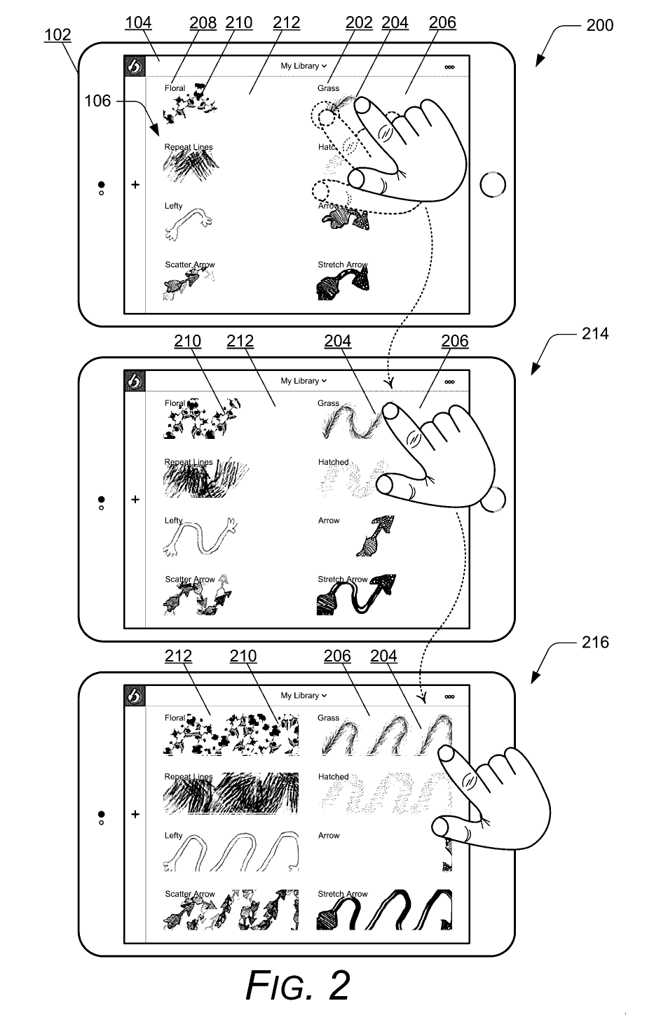

FIG. 2 illustrates an example 200 of multiple brush strokes preview. As shown and described with reference to FIG. 1, the virtual brushes interface 104 is shown displayed on the tablet device 102. A user of the device can touch and hold one of the virtual brushes 106, such as the virtual brush 202 that is the “grass” brush type to select the brush type and then draw a brush segment 204 of the virtual brush in a brush drawing surface 206 of the virtual brush. Each of the virtual brushes 106 is displayed in a respective, individual brush drawing surface, such as the virtual brush 202 of the “grass” brush type displayed in the brush drawing surface 206, a virtual brush 208 of the “floral” brush type displayed as a brush segment 210 in a brush drawing surface 212, and the like.

When the user of the device touches and holds one of the virtual brushes 106 in the virtual brushes interface 104, all of the individual brush drawing surfaces are cleared of the last displayed segment of the respective virtual brush, allowing the user to then draw a new brush segment. For example, the brush drawing surfaces shown in the virtual brushes interface 104 in FIG. 1 display brush segments of the respective brush types across the entire brush drawing surfaces, and in the example 200 shown in FIG. 2, the brush drawing surfaces are cleared when the user touches and holds one of the virtual brushes 106 in the virtual brushes interface. In this example, the user touches and holds just the one virtual brush 202 that is of the “grass” brush type and all of the brush drawing surfaces are cleared.

This example 200 also illustrates multiple brush strokes preview, as described herein. As the user draws the brush segment 204 of the virtual brush 202 in the brush drawing surface 206, the continuation of the brush segment being drawn is shown in the transition at 214, as well as the brush segment 204 shown completed at 216. At the same time, all of the brush segments of the virtual brushes 106 in the respective brush drawing surfaces are generated for display along the same drawing path, or in the same drawing form, as the brush segment 204 that the user draws. For example, the brush segment 210 of the virtual brush 208 in the “floral” brush type is displayed in a similar drawing path or drawing form in the brush drawing surface 212 as the brush segment 204 of the virtual brush 202 in the brush drawing surface 206. Additionally, the continuation of all the various brush segments being generated for display in the respective brush drawing surfaces is shown in the transition at 214, and are similarly shown completed at 216.

As the user draws a brush segment in any one of the drawing surfaces, the input data of the brush segment that is being drawn is delivered to all of the brush drawing surfaces simultaneously, which then causes all of the brush segments in the brush drawing surfaces to update synchronously in real-time for a multiple brush stroke preview. The user can then preview in the virtual brushes interface 104 what all of the brush types look like for the input drawing path or drawing form of the one particular selected brush segment (e.g., brush segment 204 in this example). A static bitmap image of a brush type can only convey limited, general information about the kind of marks that a particular virtual brush can be used to create, whereas selecting and utilizing the brush is a different, tactile user experience.

With the multiple brush strokes preview displayed in the virtual brushes interface 104, a user can scribble or draw just one segment input with a selected virtual brush 106 and see the effect on all of the brush styles in a live preview mode. As a user convenience, this provides a time-savings efficiency, rather than having to select and try out each brush individually on a canvas or in an image, and then having to erase or undo the brush strokes and start over if the user does not like the appearance of the brush type. The multiple brush strokes preview also conserves processing resources and device power by the user not having to go through the select, draw, and erase or undo process for each brush to find a brush type that is suitable for a particular application.

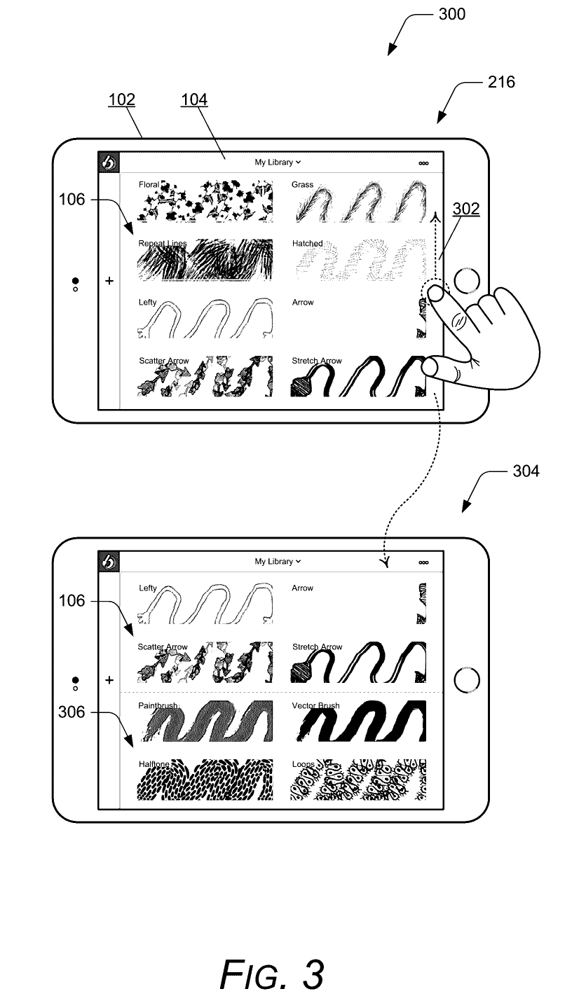

FIG. 3 illustrates another example 300 of multiple brush strokes preview. As shown and described with reference to FIGS. 1 and 2, the virtual brushes interface 104 is shown displayed on the tablet device 102, and the virtual brushes interface includes the virtual brushes 106. As described with reference to FIG. 2, all the various brush segments that are generated for display in the respective brush drawing surfaces of the virtual brushes interface 104 are shown completed at 216 (i.e., at the bottom of FIG. 2 and at the top of FIG. 3). The user can then scroll the virtual brushes interface as shown at 302 to view other virtual brushes that are not currently displayed. For example, as the user scrolls the virtual brushes interface, the device display transitions as shown at 304 and additional virtual brushes 306 are displayed for viewing.

In this example, the additional virtual brushes 306 include a “paintbrush”, a “halftone”, a “vector brush”, and “loops” brush styles that were not previously displayed. However, as the user draws the brush segment 204 of the virtual brush 202 in the brush drawing surface 206 (i.e., as shown and described with reference to FIG. 2), the brush segments of the additional virtual brushes that were not previously displayed are also updated synchronously in real-time in the respective brush drawing surfaces. When the user then scrolls the virtual brushes interface 104, the additional virtual brushes 306 that were not previously displayed are similarly shown completed at 304, where the brush segments of the virtual brushes are generated for display along the same drawing path, or in the same drawing form, as the brush segment 204 that the user drew previously.

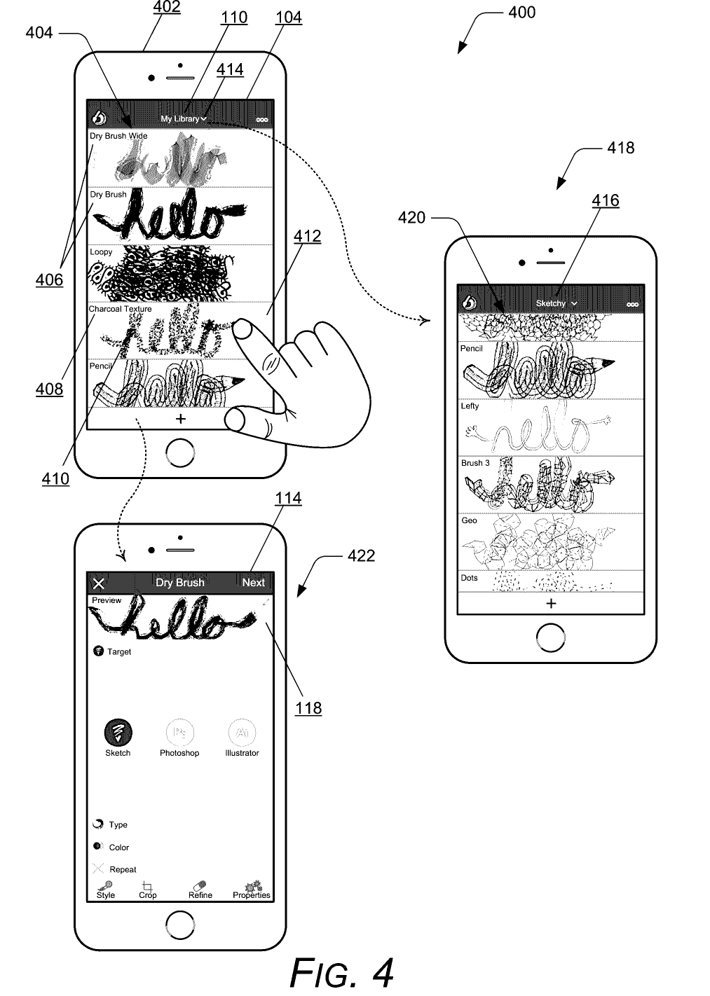

FIG. 4 illustrates another example 400 of a mobile device, such as a mobile phone 402, in which embodiments of multiple brush strokes preview can be implemented. As detailed in the system description shown in FIG. 5, the mobile phone 402 can display a smaller format of the virtual brushes interface 104 of the virtual brush application. The virtual brushes interface 104 displays the multiple virtual brushes 404 of various brush types 406, such as “dry brush”, “dry brush wide”, “pencil”, and any other brush types as shown in this example. The virtual brushes 404 are also referred to herein as simply brushes 404, and in this instance, are displayed together on the mobile phone in the brush library 110, which is identified as “My Library” to indicate the brush library of the user of the tablet device 102 and the mobile phone 402.

As described above with reference to FIG. 2, a user of the device can touch and hold one of the virtual brushes 404, such as the virtual brush 408 that is the “charcoal texture” brush type to select the brush type and then draw the brush segment 410 of the virtual brush in the brush drawing surface 412 of the virtual brush. In this example, the user has drawn or written the word “hello” as the brush segment 410, which is shown completed in the brush drawing surface 412. Each of the virtual brushes 404 is displayed in a respective, individual brush drawing surface, and as the user draws or writes the brush segment 410 (e.g., the word “hello”), all of the brush segments of the virtual brushes 404 in the respective brush drawing surfaces are generated for display along the same drawing path (e.g., also as the word “hello”). As the user draws a brush segment in any one of the drawing surfaces, the input data of the brush segment that is being drawn is delivered to all of the brush drawing surfaces simultaneously, which then causes all of the brush segments in the brush drawing surfaces to update synchronously in real-time for a multiple brush stroke preview.

As described above, the brush library 110 of the multiple virtual brushes 404 may be provided with the virtual brush application, or a brush library with different virtual brushes of various brush types can be created by the user of the device. For example, the user can select the drop-down selector 414 to display a list of alternative brush libraries, and then select a different brush library to display other virtual brushes in the virtual brushes interface 104. For example, the user can select the “sketchy” brush library 416 as shown at 418, and additional virtual brushes 420 are shown in the virtual brushes interface. As shown in the example, the brush stroke preview of the brush segment 410 (e.g., the word “hello”) is persisted to the additional virtual brushes 420 in the different brush library that is displayed in the virtual brushes interface. As the user draws the brush segment 410 of the virtual brush 408 in the brush drawing surface 412, the brush segments of the additional virtual brushes 420 in the different brush library are also updated synchronously in real-time, and when the user selects the different brush library, the additional virtual brushes 420 that were not previously displayed are similarly shown completed at 418.

As also described above, the user can touch-select one of the virtual brushes 404, such as the “dry brush” brush type to initiate the brush template interface 114 as shown at 422. The brush template interface 114 includes the selected “dry brush” brush type displayed in the preview section 118 of the brush template interface. As shown in the example, the brush stroke preview of the brush segment 410 (e.g., the word “hello”) as drawn by the user is persisted to the preview section 118 of the brush template interface 114, from which the user can then edit or create a new brush style.

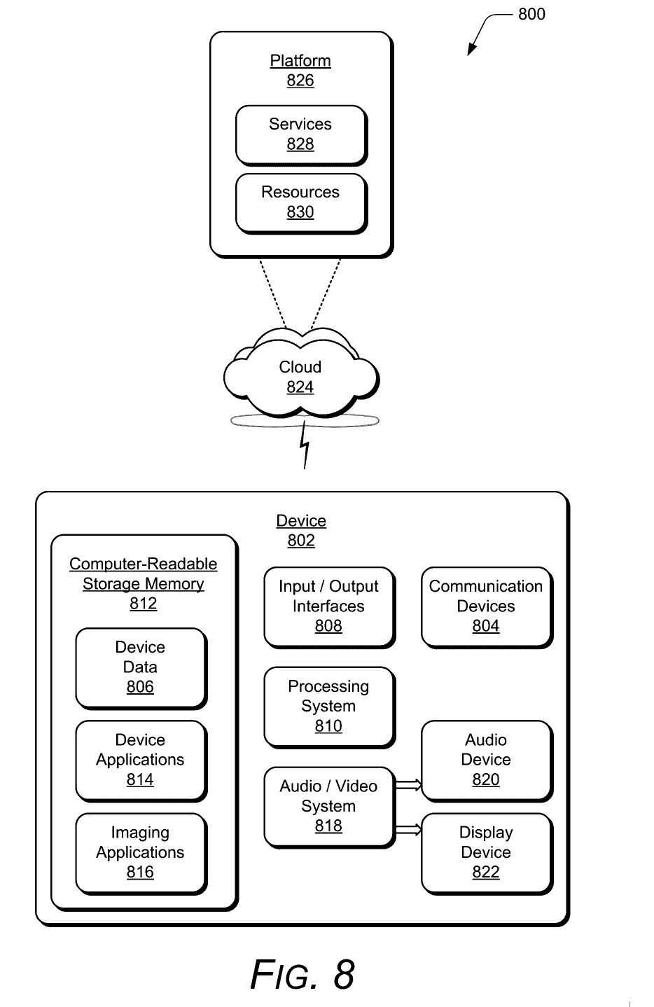

FIG. 5 illustrates an example system 500 in which embodiments of multiple brush strokes preview can be implemented. The example system 500 includes a computing device 502, such as the tablet device 102 shown in FIGS. 1-3, the mobile phone 402 shown in FIG. 4, and/or any other type of a media playback, computing, communication, gaming, entertainment, or portable electronic media device. The computing device 502 can be implemented with various components, such as a processor 504 (or processing system) and memory 506, and with any number and combination of differing components as further described with reference to the example device shown in FIG. 8. Although not shown, the computing device 502 can include a power source, such as a battery, to power the various device components. Further, the computing device 502 can include different wireless radio systems, such as for Wi-Fi, Bluetooth™, Mobile Broadband, LTE, or any other wireless communication system or format. Generally, the computing device 502 implements a communication system 508 that includes a radio device, antenna, and chipset that is implemented for wireless communication with other devices, networks, and services.

The computing device 502 includes the virtual brushes interface 104 and the brush template interface 114 of the virtual brush application 510, as referred to above. The virtual brush application 510 can be implemented as a software application or module, such as computer-executable software instructions that are executable with the processor 504 (or with a processing system) to implement embodiments of multiple brush strokes preview. The virtual brush application 510 can be stored on computer-readable storage memory (e.g., the device memory 506), such as any suitable memory device or electronic data storage implemented in the computing device.

In implementations, the virtual brushes interface can be displayed on a display of the tablet device 102 or the mobile phone 402, and the virtual brushes interface includes the brush drawing surfaces that display the virtual brushes preview 512 of each respective virtual brush 514. For example, the virtual brushes interface 104 is shown in FIG. 1 displayed on the tablet device 102, and the virtual brushes interface includes the brush drawing surfaces (e.g., the brush drawing surface 206 for the virtual brush 202), where each brush drawing surface corresponds to a virtual brush of a brush type. Similarly, the virtual brushes interface 104 is shown in FIG. 4 displayed on the mobile phone 402, and the virtual brushes interface includes the brush drawing surfaces (e.g., the brush drawing surface 412 for the virtual brush 408), where each brush drawing surface corresponds to a virtual brush of a brush type.

The virtual brush application 510 is implemented to receive a segment drawing input 516 (e.g., a user drawing input) in one of the brush drawing surfaces that is displayed in the virtual brushes interface 104. The virtual brush application can then generate, approximately simultaneously, brush segments of all the virtual brushes 514 for display in the corresponding brush drawing surfaces, where each of the brush segments are displayable in the corresponding brush drawing surface in the form of the segment drawing input. For example, the virtual brush application 510 receives a drawing input as the user draws the brush segment 204 of the virtual brush 202 in the brush drawing surface 206, as shown in FIG. 2, and the brush segment 204 shown completed at 216. Similarly, a user of the mobile phone 402 initiates the drawing input with the virtual brush 408 to draw the brush segment 410 of the virtual brush in the brush drawing surface 412, as shown in FIG. 4. Approximately simultaneously, the brush segments of all the virtual brushes are generated by the virtual brush application 510 for display in the corresponding brush drawing surfaces, and each of the brush segments are displayed in the form of the drawing input.

The virtual brush application 510 is also implemented to receive an initial touch input in one of the brush drawing surfaces before the drawing input is received; and, then clear the brush drawing surfaces so that the user can begin drawing a new brush segment. The virtual brush application 510 can also receive a touch input within a brush drawing surface of a virtual brush 514 to initiate the brush template interface 114, which is displayed to include an editable preview of the brush segment of the virtual brush, and the brush segment of the virtual brush is displayable in the form of the segment drawing input 516. For example, the brush template interface 114 shown in FIG. 4 includes the selected brush type displayed in the preview section 118 of the brush template interface, and the brush stroke preview of the brush segment 410 (e.g., the word “hello”) as drawn by the user is persisted to the preview section 118 of the brush template interface. The brush segment preview can then be edited to create a new virtual brush 518 for the virtual brush application 510 by altering the preview image based on brush-edit inputs 520.

The example system 500 also includes a cloud-based image service 522, such as Adobe Creative Cloud™ that is accessible by client devices, to include the computing device 502, the tablet device 102, and the mobile phone 402. The image service 522 includes data storage 524 that may be implemented as any suitable memory, memory device, or electronic data storage for network-based data storage. The data storage maintains a brush library 526 of virtual brushes 528 that are accessible by an imaging application 530, such as when a user accesses the imaging application 530 (e.g., as a network-based application) from a client device (e.g., the computing device 502) to create a sketch 532 or other art work with the imaging application. The computing device 502 can communicate the virtual brushes 514 to the image service 522, where the virtual brushes are then saved as the virtual brushes 528 in the brush library 526 that is accessible by the virtual brush application 510 on the computing device. The cloud-based image service 522 may also include the virtual brush application 534 as a network-based application that is accessible from a client device.

The cloud-based image service 522 can also be implemented with server devices that are representative of one or multiple hardware server devices of the image service. Further, the cloud-based image service 522 can be implemented with various components, such as a processing system and memory, as well as with any number and combination of differing components as further described with reference to the example device shown in FIG. 8 to implement the services, applications, servers, and other features of multiple brush strokes preview. The imaging application 530 and/or the virtual brush application 534 can be implemented as software applications or modules, such as executable software instructions (e.g., computer-executable instructions) that are executable with a processor or processing system of the image service.

The example system 500 also includes a network 536, and any of the devices, servers, and/or services described herein can communicate via the network, such as for data communication between the computing device 502 and the cloud-based image service 522 The network can be implemented to include a wired and/or a wireless network. The network can also be implemented using any type of network topology and/or communication protocol, and can be represented or otherwise implemented as a combination of two or more networks, to include IP-based networks and/or the Internet. The network may also include mobile operator networks that are managed by a mobile network operator and/or other network operators, such as a communication service provider, mobile phone provider, and/or Internet service provider.

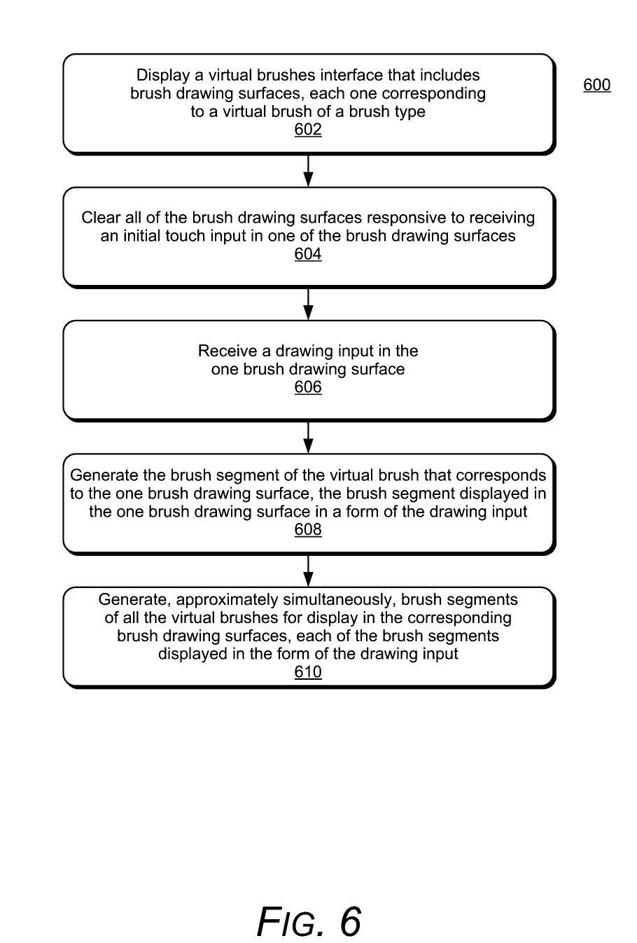

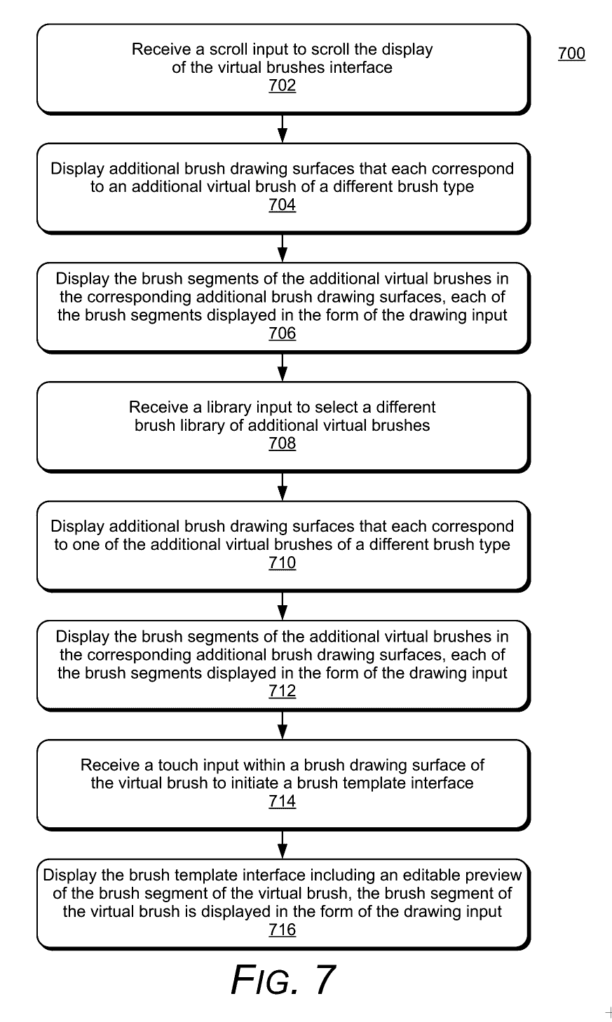

Example methods 600 and 700 are described with reference to respective FIGS. 6 and 7 in accordance with one or more embodiments of multiple brush strokes preview. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 6 illustrates example method(s) 600 of multiple brush strokes preview, and is generally described with reference to the virtual brushes interface implemented by the computing device as shown in the example system of FIG. 5. The order in which the method is described is not intended to be construed as a limitation, and any number or combination of the method operations can be combined in any order to implement a method, or an alternate method.

At 602, a virtual brushes interface is displayed that includes brush drawing surfaces, where each brush drawing surface corresponds to a virtual brush of a brush type. For example, the virtual brushes interface 104 is displayed on the tablet device 102, and the virtual brushes interface includes the brush drawing surfaces (e.g., the brush drawing surface 206 for the virtual brush 202), where each brush drawing surface corresponds to a virtual brush of a brush type. In implementations, the virtual brushes 106 that are displayed in the virtual brushes interface 104 are organized in a brush library 110. Similarly, the virtual brushes interface 104 is displayed on the mobile phone 402, and the virtual brushes interface includes the brush drawing surfaces (e.g., the brush drawing surface 412 for the virtual brush 408), where each brush drawing surface corresponds to a virtual brush of a brush type.

At 604, all of the brush drawing surfaces are cleared responsive to an initial touch input received in one of the brush drawing surfaces. For example, an initial touch input is received, such as when the user of the device touches and holds one of the virtual brushes 106 in the virtual brushes interface 104. All of the individual brush drawing surfaces are then cleared of the last displayed segment of the respective virtual brush, allowing the user to then draw a new brush segment. As shown at 200 in FIG. 2, the user touches and holds just the one virtual brush 202 that is of the “grass” brush type and all of the brush drawing surfaces in the virtual brushes interface 104 are cleared.

At 606, a drawing input is received in the one brush drawing surface selected by the user and, at 608, a brush segment of the virtual brush that corresponds to the one brush drawing surface is generated, where the brush segment is displayed in the one brush drawing surface in a form of the drawing input. For example, the virtual brush application 510 receives a drawing input as the user draws the brush segment 204 of the virtual brush 202 in the brush drawing surface 206. The continuation of the brush segment 204 being drawn is shown in the transition at 214, as well as the brush segment 204 shown completed at 216. Similarly, a user of the mobile phone 402 initiates a drawing input with the virtual brush 408 to draw the brush segment 410 of the virtual brush in the brush drawing surface 412 of the virtual brush. For example, the user draws or writes the word “hello” as the brush segment 410, which is shown completed in the brush drawing surface 412.

At 610, approximately simultaneously, brush segments of all the virtual brushes are generated for display in the corresponding brush drawing surfaces, and each of the brush segments are displayed in the form of the drawing input. For example, the virtual brush application 510 generates all of the brush segments of the virtual brushes 106 in the respective brush drawing surfaces for display along the same drawing path, or in the same drawing form, as the brush segment 204 that the user draws. For example, the brush segment 210 of the virtual brush 208 in the “floral” brush type is displayed in a similar drawing path or drawing form in the brush drawing surface 212 as the brush segment 204 of the virtual brush 202 in the brush drawing surface 206. Additionally, the continuation of all the various brush segments being generated for display in the respective brush drawing surfaces is shown in the transition at 214, and are shown completed at 216. The brush segments of all the virtual brushes 106 that are generated approximately simultaneously are displayed in the virtual brushes interface 104 as a multiple brush strokes preview of the respective brush types. Similarly, each of the virtual brushes 404 shown in the virtual brushes interface 104 on the mobile phone 402 are displayed in a respective, individual brush drawing surface, and as the user draws or writes the brush segment 410 (e.g., the word “hello”), all of the brush segments of the virtual brushes 404 in the respective brush drawing surfaces are generated for display along the same drawing path (e.g., also as the word “hello”).

FIG. 7 illustrates example method(s) 700 of multiple brush strokes preview, and is generally described with reference to the virtual brushes interface implemented by the computing device as shown in the example system of FIG. 5. The order in which the method is described is not intended to be construed as a limitation, and any number or combination of the method operations can be combined in any order to implement a method, or an alternate method.

At 702, a scroll input is received to scroll the display of the virtual brushes interface, and at 704, additional brush drawing surfaces are displayed that each correspond to an additional virtual brush of a different brush type. For example, the virtual brush application 510 receives the scroll input to scroll the virtual brushes interface as shown at 302 to view other virtual brushes, and as the user scrolls the virtual brushes interface 104, the device display transitions as shown at 304 and the additional virtual brushes 306 are displayed for viewing.

At 706, the brush segments of the additional virtual brushes are displayed in the corresponding additional brush drawing surfaces, where each of the brush segments are displayed in the form of the drawing input. For example, the additional virtual brushes 306 that were not previously displayed are similarly shown completed at 304, where the brush segments of the virtual brushes are generated for display along the same drawing path, or in the same drawing form, as the brush segment 204 that the user drew previously. The brush segments of the additional virtual brushes 306 are generated by the virtual brush application 510 when the brush segments of all the virtual brushes are generated.

At 708, a library input is received to select a different brush library of additional virtual brushes, and at 710, additional brush drawing surfaces are displayed that each correspond to one of the additional virtual brushes of a different brush type. For example, the virtual brush application 510 receives a library input when the user selects the drop-down selector 414 in the virtual brushes interface 104 to display a list of alternative brush libraries, and then selects a different brush library to display the additional virtual brushes 420 in the virtual brushes interface 104.

At 712, the brush segments of the additional virtual brushes are displayed in the corresponding additional brush drawing surfaces, where each of the brush segments are displayed in the form of the drawing input. For example, the brush stroke preview of the brush segment 410 (e.g., the word “hello”) is persisted to the additional virtual brushes 420 in the different brush library 416 that is displayed in the virtual brushes interface 104. As the user draws the brush segment 410 of the virtual brush 408 in the brush drawing surface 412, the brush segments of the additional virtual brushes 420 in the different brush library are also updated, and when the user selects the different brush library, the additional virtual brushes 420 that were not previously displayed are similarly shown completed at 418. The brush segments of the additional virtual brushes 420 in the different brush library 416 are generated by the virtual brush application 510 when the brush segments of all the virtual brushes are generated.

At 714, a touch input is received within a brush drawing surface of the virtual brush to initiate a brush template interface, and at 716, the brush template interface is displayed including an editable preview of the brush segment of the virtual brush, where the brush segment of the virtual brush is displayed in the form of the drawing input. For example, the virtual brush application 510 receives a touch input when the user touch-selects one of the virtual brushes 404, such as the “dry brush” brush type to initiate the brush template interface 114 as shown at 422. The brush template interface 114 includes the selected “dry brush” brush type displayed in the preview section 118 of the brush template interface, and the brush stroke preview of the brush segment 410 (e.g., the word “hello”) as drawn by the user is persisted to the preview section 118 of the brush template interface 114.

FIG. 8 illustrates an example system 800 that includes an example device 802, which can implement embodiments of multiple brush strokes preview. The example device 802 can be implemented as any of the computing devices and/or services (e.g., server devices) described with reference to the previous FIGS. 1-7, such as any type of computing device, client device, mobile phone, tablet, communication, entertainment, gaming, media playback, and/or other type of device. For example, the tablet device 102, the mobile phone 402, the computing device 502, and/or server devices of the cloud-based image service 522 may be implemented as the example device 802.

The device 802 includes communication devices 804 that enable wired and/or wireless communication of device data 806, such as brush templates and imaging applications content that is transferred from one computing device to another, and/or synched between multiple computing devices. The device data can include any type of audio, video, and/or image data that is generated by applications executing on the device. The communication devices 804 can also include transceivers for cellular phone communication and/or for network data communication.

The device 802 also includes input/output (I/O) interfaces 808, such as data network interfaces that provide connection and/or communication links between the device, data networks, and other devices. The I/O interfaces can be used to couple the device to any type of components, peripherals, and/or accessory devices, such as a digital camera device that may be integrated with device 802. The I/O interfaces also include data input ports via which any type of data, media content, and/or inputs can be received, such as user inputs to the device, as well as any type of audio, video, and/or image data received from any content and/or data source.

The device 802 includes a processing system 810 that may be implemented at least partially in hardware, such as with any type of microprocessors, controllers, and the like that process executable instructions. The processing system can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The device 802 may further include any type of a system bus or other data and command transfer system that couples the various components within the device. A system bus can include any one or combination of different bus structures and architectures, as well as control and data lines.

The device 802 also includes computer-readable storage memory 812, such as data storage devices that can be accessed by a computing device, and that provide persistent storage of data and executable instructions (e.g., software applications, modules, programs, functions, and the like). The computer-readable storage memory described herein excludes propagating signals. Examples of computer-readable storage memory include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage memory in various memory device configurations.

The computer-readable storage memory 812 provides storage of the device data 806 and various device applications 814, such as an operating system that is maintained as a software application with the computer-readable storage memory and executed by the processing system 810. In this example, the device applications also include imaging applications 816 that implement embodiments of multiple brush strokes preview, such as when the example device 802 is implemented as the computing device 502 shown in FIG. 5. Examples of the imaging application 816 includes the virtual brush application 510 that is implemented by the computing device 502 and the imaging application 530 that is implemented by the cloud-based image service 522, as described with reference to FIG. 5.

The device 802 also includes an audio and/or video system 818 that generates audio data for an audio device 820 and/or generates display data for a display device 822. The audio device and/or the display device include any devices that process, display, and/or otherwise render audio, video, display, and/or image data, such as the image content of a digital photo. In implementations, the audio device and/or the display device are integrated components of the example device 802. Alternatively, the audio device and/or the display device are external, peripheral components to the example device. In embodiments, at least part of the techniques described for multiple brush strokes preview may be implemented in a distributed system, such as over a “cloud” 824 in a platform 826. The cloud 824 includes and/or is representative of the platform 826 for services 828 and/or resources 830. For example, the services 828 may include the cloud-based image service described with reference to FIG. 5.

The platform 826 abstracts underlying functionality of hardware, such as server devices (e.g., included in the services 828) and/or software resources (e.g., included as the resources 830), and connects the example device 802 with other devices, servers, etc. The resources 830 may also include applications and/or data that can be utilized while computer processing is executed on servers that are remote from the example device 802. Additionally, the services 828 and/or the resources 830 may facilitate subscriber network services, such as over the Internet, a cellular network, or Wi-Fi network. The platform 826 may also serve to abstract and scale resources to service a demand for the resources 830 that are implemented via the platform, such as in an interconnected device embodiment with functionality distributed throughout the system 800. For example, the functionality may be implemented in part at the example device 802 as well as via the platform 826 that abstracts the functionality of the cloud 824.

Although embodiments of multiple brush strokes preview have been described in language specific to features and/or methods, the appended claims are not necessarily limited to the specific features or methods described. Rather, the specific features and methods are disclosed as example implementations of multiple brush strokes preview, and other equivalent features and methods are intended to be within the scope of the appended claims. Further, various different embodiments are described and it is to be appreciated that each described embodiment can be implemented independently or in connection with one or more other described embodiments.

1. A method to simultaneously preview multiple brush strokes created by multiple virtual brushes, the method comprising:
displaying a virtual brushes interface that includes brush drawing surfaces, each brush drawing surface corresponding to a virtual brush of a brush type;
receiving a drawing input in one of the brush drawing surfaces;
generating a brush segment of the virtual brush that corresponds to the one brush drawing surface, the brush segment displaying in the one brush drawing surface in a form of the drawing input; and
generating, approximately simultaneously, brush segments of all the virtual brushes for display in the corresponding brush drawing surfaces, each of the brush segments displaying in the corresponding brush drawing surface in the form of the drawing input.

2. The method as recited in claim 1, further comprising:
receiving an initial touch input in the one brush drawing surface before receiving the drawing input; and
clearing the brush drawing surfaces responsive to receiving the initial touch input to the one brush drawing surface.

3. The method as recited in claim 1, wherein the brush segments of all the virtual brushes are generated approximately simultaneously for display as a multiple brush strokes preview of the respective brush types.

4. The method as recited in claim 1, further comprising:
receiving a scroll input to scroll the display of the virtual brushes interface;
displaying additional brush drawing surfaces that each correspond to an additional virtual brush of a different brush type; and
displaying the brush segments of the additional virtual brushes in the corresponding additional brush drawing surfaces, each of the brush segments displayed in the form of the drawing input.

5. The method as recited in claim 4, further comprising:
generating the brush segments of the additional virtual brushes when generating the brush segments of all the virtual brushes.

6. The method as recited in claim 1, wherein the virtual brushes that are displayed in the virtual brushes interface are organized in a brush library, the method further comprising:
receiving a library input to select a different brush library of additional virtual brushes;
displaying additional brush drawing surfaces that each correspond to one of the additional virtual brushes of a different brush type; and
displaying the brush segments of the additional virtual brushes in the corresponding additional brush drawing surfaces, each of the brush segments displayed in the form of the drawing input.

7. The method as recited in claim 6, further comprising:
generating the brush segments of the additional virtual brushes in the different brush library when generating the brush segments of all the virtual brushes.

8. The method as recited in claim 1, further comprising:
receiving a touch input within a brush drawing surface of the virtual brush to initiate a brush template interface; and
displaying the brush template interface including an editable preview of the brush segment of the virtual brush, wherein the brush segment of the virtual brush is displayed in the form of the drawing input.

9. A computing device implemented to create a simultaneous preview of brush strokes of corresponding virtual brushes, the computing device comprising:
a display device configured to display a virtual brushes interface that includes brush drawing surfaces, each brush drawing surface corresponding to a virtual brush of a brush type;
a memory and processor system configured to execute a virtual brush application that is implemented to:
receive a drawing input in one of the brush drawing surfaces;
generate a brush segment of the virtual brush that corresponds to the one brush drawing surface, the brush segment displayable in the one brush drawing surface in a form of the drawing input; and
generate, approximately simultaneously, brush segments of all the virtual brushes for display in the corresponding brush drawing surfaces, each of the brush segments displayable in the corresponding brush drawing surface in the form of the drawing input.

10. The computing device as recited in claim 9, wherein the virtual brush application is implemented to:
receive an initial touch input in the one brush drawing surface before the drawing input is received; and
clear the brush drawing surfaces in response to the initial touch input in the one brush drawing surface.

11. The computing device as recited in claim 9, wherein the virtual brush application is implemented to generate, approximately simultaneously, the brush segments of all the virtual brushes for display as a multiple brush strokes preview of the respective brush types.

12. The computing device as recited in claim 9, wherein the virtual brush application is implemented to:
receive a scroll input of the virtual brushes interface to display additional brush drawing surfaces that each correspond to an additional virtual brush of a different brush type; and
the brush segments of the additional virtual brushes in the corresponding additional brush drawing surfaces are displayable in the form of the drawing input.

13. The computing device as recited in claim 12, wherein the virtual brush application is implemented to generate the brush segments of the additional virtual brushes when the brush segments of all the virtual brushes are generated.

14. The computing device as recited in claim 9, wherein:
the virtual brushes that are displayed in the virtual brushes interface are organized in a brush library;
the virtual brush application is implemented to receive a library input to select a different brush library of additional virtual brushes;
the display device is configured to:
display additional brush drawing surfaces in the virtual brushes interface, the additional brush drawing surfaces each corresponding to one of the additional virtual brushes of a different brush type; and
display the brush segments of the additional virtual brushes in the corresponding additional brush drawing surfaces, each of the brush segments displayable in the form of the drawing input.

15. The computing device as recited in claim 14, wherein the virtual brush application is implemented to generate the brush segments of the additional virtual brushes in the different brush library when the brush segments of all the virtual brushes are generated.

16. The computing device as recited in claim 9, wherein:
the virtual brush application is implemented to receive a touch input within a brush drawing surface of the virtual brush to initiate a brush template interface; and
the display device is configured to display the brush template interface including an editable preview of the brush segment of the virtual brush, wherein the brush segment of the virtual brush is displayable in the form of the drawing input.

17. A method to preview multiple brush strokes created by multiple virtual brushes, the method comprising, comprising:
receiving a drawing input within a brush drawing surface in a virtual brushes interface that includes brush drawing surfaces each corresponding to a virtual brush of a brush type; and
generating, approximately simultaneously, brush segments of all the virtual brushes for display in the corresponding brush drawing surfaces, each of the brush segments displaying in the corresponding brush drawing surface in the form of the drawing input.

18. The method as recited in claim 17, further comprising:
clearing the brush drawing surfaces displayed in the virtual brushes interface prior to generating the brush segments of all the virtual brushes for display.

19. The method as recited in claim 17, further comprising:
scrolling the display of the virtual brushes interface to display additional brush drawing surfaces that each correspond to an additional virtual brush; and
displaying the brush segments of the additional virtual brushes in the corresponding additional brush drawing surfaces, each of the brush segments displayed in the form of the drawing input.

20. The method as recited in claim 19, further comprising:
generating the brush segments of the additional virtual brushes when generating the brush segments of all the virtual brushes.
